(19) United States
(12) Patent Application Publication
(10) Pub. No.: US 2025/0383898 A1
(43) Pub. Date: Dec. 18, 2025

(54) ELECTRONIC CONTROL DEVICE

(71) Applicant: Hitachi Astemo, Ltd., Hitachinaka-shi, Ibaraki (JP)

(72) Inventor: Tomohito EBINA, Hitachinaka-shi, Ibaraki (JP)

(73) Assignee: Hitachi Astemo, Ltd., Hitachinaka-shi, Ibaraki (JP)

(21) Appl. No.: 19/111,263

(22) PCT Filed: Sep. 26, 2022
(86) PCT No.: PCT/JP2022/035623

§ 371 Date: Mar. 12, 2025

(51) Int. Cl. G06F 9/455

(52) U.S. Cl. CPC G06F 9/455

(57) ABSTRACT

An electronic control device, wherein the operating system includes a host OS library in which a function to be called is recorded during execution of the program, wherein the program includes executable command code and a common IF unit in which a jump destination of a function called by the program is recorded, wherein the intermediate layer library includes an emulation unit including a function emulator that implements another function by combining functions stored in the host OS library, and an IF conversion unit that converts an address for the common IF unit to call the emulation unit and the host OS library, and wherein the operating system, the intermediate layer library, and the program are introduced to the electronic control device separately.

### TECHNICAL FIELD

The present invention relates to an arithmetic processing technology of a vehicle control device.

### BACKGROUND ART

A vehicle control system includes an ECU that operates an electronic vehicle control device, that is, an electronic control unit, the system controlling a vehicle through the collaborative operation of a plurality of ECUs performing communication via a CAN, Ethernet, or the like.

With recent improvements in the performance of microcomputers for vehicles (virtual memory function, multi-coring), achieving space-saving and cost reduction by providing one integrated ECU with a plurality of functions in a vehicle control system has been studied.

As described above, a method has been studied that enables a plurality of ECUs to operate collaboratively and a program to be executed by means of a microcomputer having a plurality of arithmetic cores.

Technology enabling ECUs to operate collaboratively and a plurality of arithmetic cores to be used include the technology disclosed in the following Patent Literature.

For example, PTL 1 (Japanese Patent Application Laid-Open No. 2017-128308) discloses a vehicle control system in which a first OS program held by a master ECU acquires information on a role shared by a second OS program held by a slave ECU, and, on the basis of the information on the role shared by the second OS program, determines a role shared by the first OS program, to enable the first OS program to operate collaboratively with the second OS program.

In addition, PTL 2 (Japanese Patent Application Laid-Open No. 2015-229467) discloses an electronic control system in which one ECU among a plurality of ECUs includes a plurality of cores capable of performing computation in parallel, and a ROM that stores programs used by the plurality of cores, wherein the ROM stores the programs which are mutually independent for each core, wherein first to third cores serving as sub-cores perform, on the basis of the programs in the ROM, computation related to control of control systems which each core governs, and wherein a fourth core serving as a main core performs computation related to cooperative control between the plurality of control systems, receives a support request from another ECU, and provisions at least part of the computation related to the support to any one of the sub-cores in association with the program for each sub-core.

### CITATION LIST

### Patent Literature

PTL 1: JP 2017-128308 A

PTL 2: JP 2015-229467 A

### SUMMARY OF INVENTION

### Technical Problem

Vehicle-mounted ECUs are generally manufactured by a plurality of suppliers. In addition, even for ECUs manufactured by the same supplier, cost reduction may be achieved by selecting a microcomputer that affords minimum performance while satisfying functions, or by changing the OS to be adopted. Therefore, in a case where a next-generation ECU is being developed or a function is to be integrated and built into another ECU, porting work to correct the source code is required.

In the porting work, compiling to convert the corrected source code into command code for a microcomputer is performed using a tool called a compiler. The use of a compiler presents problems specific to automobiles.

In recent years, to improve the reliability of ECUs, development based on the assumption that there are bugs present in the tools (compilers) being used has been necessary. Therefore, even in cases where a program employing the same source code is recompiled, retesting is performed just in case. As described above, the concept of placing emphasis on the binary of the command code, which is the compiling result, is unique to automobiles, and is different from open-source porting work for PCs, in which case the command code is distributed using source code, compiled and executed in an execution environment. In addition, when the memory address where a program operates changes, problems may arise, and thus, from the viewpoint of stability, it is also important that the memory address be a fixed address.

The above-described concept of binary emphasis is also important in the case of an integrated ECU. In the case of an integrated ECU, it is necessary to install not only an ECU program created by the company which manufactured the ECU, but also an ECU program created by another company, and because porting work is required, provision using source code is also necessary. However, the source code is highly readable and there is a risk of know-how being leaked, and thus the protection of intellectual property is an issue.

Further advancing the concept of an integrated ECU requires a load distribution approach for transferring processing to another ECU in a case where there is an increase in the computational load on a certain ECU. An information system of a PC or the like is afforded compatibility at a binary level by using the same OS, and so forth, and therefore load distribution can be implemented relatively easily. However, in the case of an ECU, resources such as memory and storage areas are also kept to the minimum required for the purpose of reducing costs. It is also difficult to make OSs uniform due to the ideology of suppliers and the convenience of conventional assets. Furthermore, in a case where a plurality of binaries is integrated, there is a problem that memory addresses conflict with each other in each binary.

The present invention was conceived of to solve the above-described problems, and an object thereof is to execute the same execution binary using different OSs of ECUs with limited resources.

### Solution to Problem

In order to solve the above-described problems, a representative example of the invention disclosed in the present application is as outlined below. That is, an electronic control device includes a processor that executes a program operating on an operating system, and a storage device that stores the program, wherein the storage device stores the operating system, the program, and an intermediate layer library operating on the operating system, which are individually configured, wherein the operating system includes a host OS library in which a function to be called is recorded during execution of the program, wherein the program includes executable command code and a common IF unit in which a jump destination of a function called by the program is recorded, wherein the intermediate layer library includes an emulation unit including a function emulator that implements another function by combining functions stored in the host OS library, and an IF conversion unit that converts an address for the common IF unit to call the emulation unit and the host OS library, and wherein the operating system, the intermediate layer library, and the program are introduced to the electronic control device separately.

### ADVANTAGEOUS EFFECTS OF INVENTION

According to one aspect of the present invention, the same execution binary can be executed by an electronic control device having different OSs, and thus an integrated electronic control device having a plurality of functions can be implemented. Problems, configurations, and advantageous effects other than those described above will be clarified by the Description of Embodiments hereinbelow.

### BRIEF DESCRIPTION OF DRAWINGS

FIG. 1A is a configuration diagram of a development environment of an electronic control device according to a first embodiment.

FIG. 1B is a configuration diagram of arithmetic processing of an execution environment constituting the electronic control device according to the first embodiment.

FIG. 2A is a configuration diagram of a development environment of an electronic control device according to a second embodiment.

FIG. 2B is a configuration diagram of arithmetic processing of an execution environment constituting the electronic control device according to the second embodiment.

FIG. 3 is a configuration diagram of an electronic control device constituting the execution environment according to the second embodiment.

### DESCRIPTION OF EMBODIMENTS

Hereinafter, embodiments of the present invention will be described with reference to the drawings.

### Embodiment 1

A program for controlling an electronic control unit (ECU) operates under an operating system (OS). The program inputs and outputs data to and from the outside of the ECU, and calls OS library functions during execution of the program. As a result, the program is capable of using functions provided as functions by the OS.

The electronic control device according to the present embodiment is a microcomputer and an OS that occupy execution memory for each program, and have a virtual memory function enabling usage of the same address as that of another program. In recent years, the virtual memory function has been adopted for vehicle-mounted electronic control devices, and is a function for provisioning, for each program, a memory space set at an arbitrary address, and involving a memory management method unlike that of a conventional electronic control device.

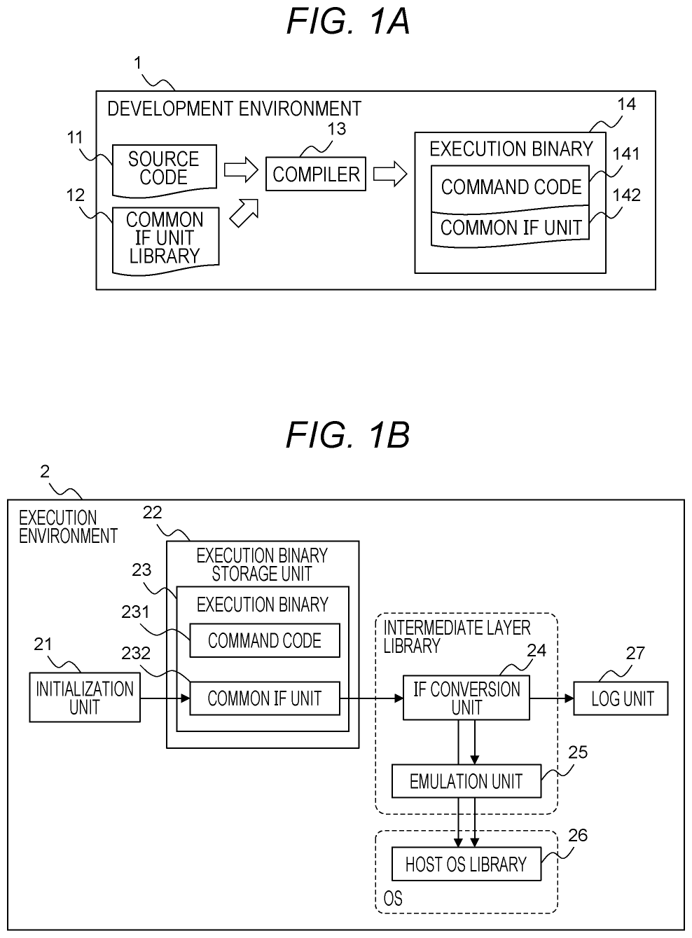

FIG. 1A is a configuration diagram of a development environment 1 of an electronic control device according to a first embodiment of the present invention, and illustrates program creation. FIG. 1B is a configuration diagram of an execution environment 2 constituting an electronic control device according to the first embodiment, and shows arithmetic processing by executing a program.

The development environment 1 includes a computer used by a developer, and a compiler 13 operates in the development environment 1. The compiler 13 uses the source code 11 and the common IF unit library 12 as inputs, and generates an execution binary 14 in which an executable command code 141 and a common IF unit 142 are combined. The common IF unit 142 is a functional unit that calls the IF conversion unit 24 from a function call in the execution binary 14. The common IF unit library 12 is a library in which the jump destination of the function required by the command code 141 is recorded. The common IF unit 142 records the jump destination, extracted from the common IF unit library 12, of the function required for execution of the command code 141.

The execution environment 2 is an electronic control device mounted in an actual vehicle, and includes a processor that executes a program and a storage area for storing the program. The execution environment 2 includes an initialization unit 21, an execution binary storage unit 22, an IF conversion unit 24, an emulation unit 25, a host OS library 26, and a log unit 27. The execution binary storage unit 22 stores an execution binary 23 in which the execution binary 14 created in the development environment 1 is duplicated. A command code 231 of the execution binary 23 is a copy of the command code 141 of the development environment 1, and a common IF unit 232 is a copy of the common IF unit 142 of the development environment 1. The IF conversion unit 24 converts an address for the common IF unit 232 to call the emulation unit 25 or the host OS library 26. The emulation unit 25 includes a function emulator that combines functions stored in the host OS library 26 to implement desired functions. The host OS library 26 is a function of an operating system that, during execution of the execution binary 23, records a function to be called of a function of the common IF unit 232. The IF conversion unit 24 and the emulation unit 25 configure an intermediate layer library that executes processing specific to each OS, and have a function for absorbing differences between the OSs.

The compiler 13 converts the source code 11 into the command code 141 which is executable by the ECU. At this time, the compiler 13 extracts the functions referenced by the source code 11 from the library and combines the functions. In the present embodiment, in a case where the source code 11 references an OS library function, the compiler 13 extracts a required function from the common IF unit library 12, configures the common IF unit 142, and combines the function with the command code 141. The common IF unit library 12 (the jump destination of the function indicated by the IF conversion unit 24) according to the present embodiment becomes part of the execution binary 14 as the common IF unit 142, jumps to the IF conversion unit 24 when the command code 141 is executed, and executes a function of the emulation unit 25 or the host OS library 26. However, because the jump address to the IF conversion unit 24 of the execution environment 2 is unknown at the time of generation in the development environment 1, a temporary value (for example, 0) may be stored.

When the execution binary 14 generated in the development environment 1 and copied to the execution environment 2 is executed in the execution environment 2, the initialization unit 21 rewrites the common IF unit 232 of the execution binary storage unit 22. For example, when the command code 231 calls the common IF unit 232, the jump processing and the jump destination address of the common IF unit 232 are rewritten so as to jump to an address of the IF conversion unit 24 which corresponds to the function to be executed.

Next, the processor of the execution environment 2 calls start processing of the command code 231 in the execution binary 23. The start processing may be the header of the command code 231, or may be a specific function name such as main or entry in the command code.

The execution binary 23 stored in the execution binary storage unit 22 may be stored in advance in the storage area of the execution environment 2, or may be read from another device via a network.

When the function of the common IF unit 232 is called during the execution of the command code 231 of the execution binary 23, the jump is made to the corresponding IF conversion unit 24. The IF conversion unit 24 jumps to the corresponding host OS library 26, executes the function, and continues the processing.

At this time, in a case where the version of the OS in the execution environment 2 is different from the version assumed in the development environment 1, the specification of the functional interface of the host OS library 26 is sometimes different. For example, a register storing an argument is different, or the specifications of the argument are different. In this case, the IF conversion unit 24 converts the register and the argument, and calls the host OS library 26.

In addition, when the OSs are different, there may be no function to be called. In a case where there is no function to be called, the common IF unit 232 calls the emulation unit 25. The emulation unit 25 combines the functions stored in the host OS library 26 to implement a desired function.

In a case where, due to an OS limitation, the emulation unit 25 does not include an emulator for implementing a desired function, the IF conversion unit 24 returns an error code to the execution binary 23. The execution binary 23 monitors an error caused by the execution of a program and detects the error by means of the error code transmitted from the IF conversion unit 24.

In an electronic control device, the capacity of a storage area is often restricted for the purpose of cost reduction. Therefore, only an OS library function which is frequently used is executable by the IF conversion unit 24 or the emulation unit 25, and other functions may be regarded as errors. The log unit 27 stores error information and the presence or absence of emulators determined by the IF conversion unit 24. The emulation unit 25 determines functions which are to be added or deleted using the information stored in the log unit 27. For example, the emulation unit 25 is updated such that a function of a high usage frequency remains and a function of a low usage frequency is deleted.

### Embodiment 2

In a second embodiment of the present invention, the same execution binary can be operated by different ECUs. In the second embodiment, differences from the first embodiment described above will be mainly described, and the same components as those in the first embodiment will be denoted by the same reference signs, and thus descriptions thereof will be omitted.

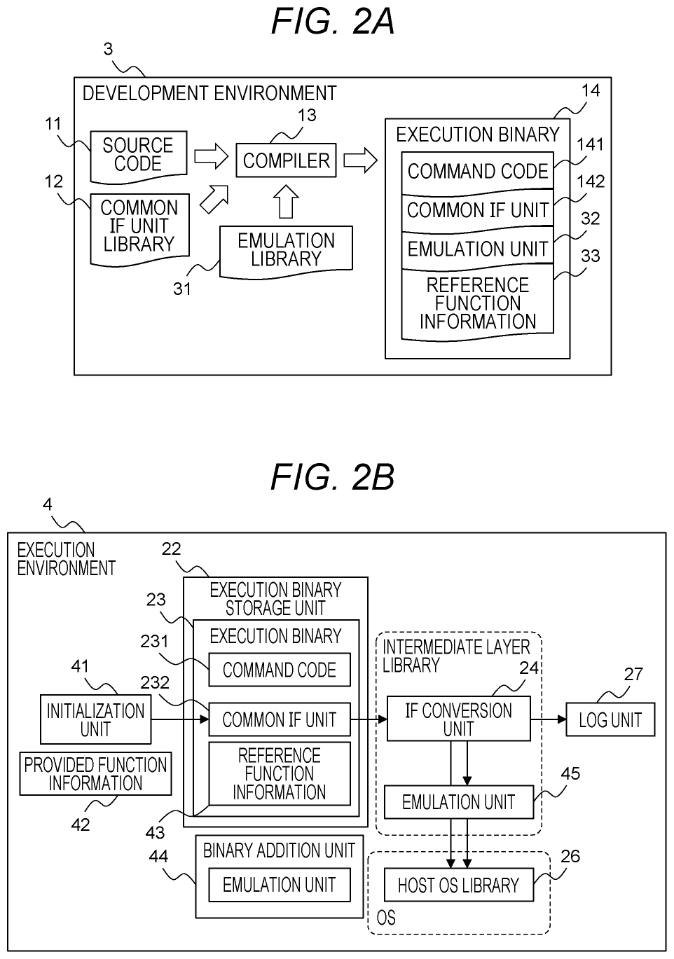

FIG. 2A is a configuration diagram of a development environment 1 of an electronic control device according to a second embodiment of the present invention and illustrates program creation. FIG. 2B is a configuration diagram of the execution environment 2 constituting the electronic control device according to the second embodiment, and illustrates arithmetic processing by executing a program.

Using a concept pertaining to vehicle control with an emphasis on operation stability, an emulation unit 45 may be stored in the execution binary 23 by taking into account differences in the emulation unit 45 of the execution environment 4. Alternatively, in order to reduce the memory at the time of execution, the emulation unit 45 of the execution environment 4 may be called.

In a development environment 3, an emulation library 31 in which function emulators are stored is provided, a required function emulator is acquired from the emulation library 31, and the acquired function emulator is combined with an emulation unit 32 in an execution binary. At such time, a function used by the emulation unit 32 and a function referenced by the execution binary 23 are stored in reference function information 33.

In the execution environment 4, an initialization unit 41 collates provided function information 42 together with reference function information 43 of the execution binary 23. The reference function information 43 duplicates the reference function information 33 of the development environment 3 and stores functions used by the emulation unit 45. Among the functions referenced by the execution binary 23 stored in the reference function information 43, only functions not prepared by the emulation unit 45 of the execution environment 4 are read into a binary addition unit 44, and therefore only the required functions can be read, thus enabling the memory usage amount to be reduced.

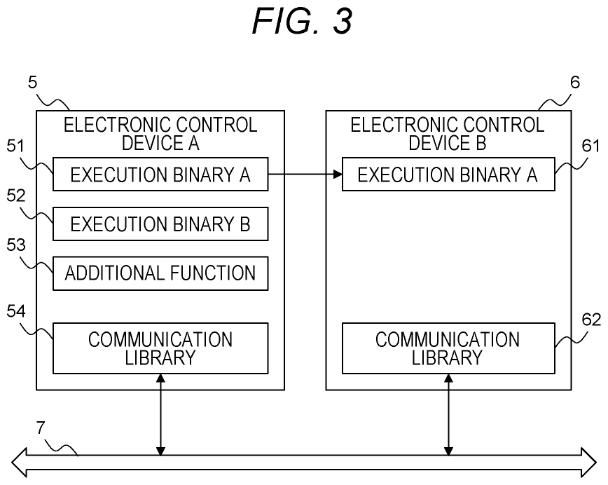

FIG. 3 is a configuration diagram of an electronic control device constituting the execution environment according to the second embodiment.

In an electronic control unit A5, the execution binary A51 and the execution binary B52 operate, and data is inputted and outputted between the execution binaries via a communication library 54. Here, in a case where an additional function 53 is added by a system update or the like of the electronic control device A5, there is an increase in the resources (calculation load, memory load) of the electronic control device. Therefore, the execution binary A51 is copied to an electronic control unit B6, and an execution binary A61 is disposed in the electronic control unit B6 and operated by the electronic control unit B6. A communication library 62 determines a data input/output destination of the execution binary A61, and in a case where the data input/output destination of the execution binary A61 is another electronic control device (the electronic control device A5), relays data input/output with the execution binary (for example, the execution binary B52) executed by the electronic control device A5 via a network 7 and the communication library 54.

The OS operating on the electronic control device A5 and the OS operating on the electronic control device B6 are sometimes different, and thus the functions provided by the OS may differ or the specifications of the arguments of the functions may be different. Therefore, as illustrated in FIGS. 2A and 2B, the emulation library 31 is provided in the development environment 3, and only functions not prepared by the emulation unit 45 in the execution environment 4 are read into the binary addition unit 44, and therefore the execution binary can be migrated between electronic control devices irrespective of the OS operating on the electronic control device A5 and the OS operating on the electronic control device B6.

By dynamically changing the configuration of the program in this manner, the resources used by the electronic control unit A5 can be reduced, and the operation of the execution binary A61 and the execution binary B52 can be continued.

As described above, the electronic control device according to an embodiment of the present invention includes includes a processor that executes a program (the execution binary 23) operating on an operating system, and a storage device that stores the program, wherein the storage device stores the operating system, the program, and an intermediate layer library operating on the operating system, which are individually configured, wherein the operating system includes a host OS library 26 in which a function to be called is recorded during execution of the program, wherein the program includes executable command code 231 and a common IF unit 232 in which a jump destination of a function called by the program is recorded, wherein the intermediate layer library includes an emulation unit 25 including a function emulator that implements another function by combining functions stored in the host OS library 26, and an IF conversion unit 24 that converts an address for the common IF unit 232 to call the emulation unit 25 and the host OS library 26, and wherein the operating system, the intermediate layer library, and the program are introduced to the electronic control device separately. That is, the program is configured divided into an intermediate layer library that executes processing specific to each OS and an execution binary that is separated from the part of the program that performs processing common to all OSs, and the emulation unit 25 and the IF conversion unit 24 of the intermediate layer library have a function for absorbing differences between the OSs. Therefore, the same execution binary can be executed by ECUs having different OSs, and an integrated ECU having a plurality of functions can be implemented.

In addition, the program includes the reference function information 43 in which functions used by the emulation unit 25 and functions referenced by the command code 231 are stored, and includes the binary addition unit 44 that stores, among the functions referenced by the command code 231, functions not prepared by the emulation unit 25, and therefore only the required functions can be implemented, thus enabling the memory usage amount to be reduced. The execution binary can also be migrated between electronic control units.

Furthermore, the log unit 27 for storing the error information determined by the IF conversion unit 24 is provided, and the emulation unit 25 uses the information stored in the log unit 27 to update the functions so as to leave functions having a high usage frequency and delete functions having a low usage frequency. Therefore, only the required functions can be implemented, and thus the memory usage amount can be reduced.

Additionally, in a case where the program is migrated from another electronic control device, a function not prepared by the emulation unit 45 among the functions referenced by the migrated program is stored in the binary addition unit 44, and therefore the electronic control device executing the program can be arbitrarily changed.

Note that the present invention is not limited to the above-described embodiments and includes various modifications and equivalent configurations within the spirit of the appended claims. For example, the above-described embodiments have been described in detail to facilitate understanding of the present invention, but the present invention is not necessarily limited to including all the described configurations. Further, part of the configuration of one embodiment may be replaced with the configuration of another embodiment. In addition, the configuration of another embodiment may be added to the configuration of a certain embodiment. Further, part of the configuration of each embodiment may be added, deleted, or replaced with another configuration.

In addition, some or all of the above-described configurations, functions, processing units, processing means, and the like may be implemented by hardware by means of a design using an integrated circuit, or may be implemented by software by a processor interpreting and executing a program for implementing each function.

Information such as a program, a table, and a file for implementing each function can be stored on a storage device such as memory, a hard disk, or a solid state drive (SSD), or on a recording medium such as an IC card, an SD card, or a DVD.

Moreover, control lines and information lines indicate what is deemed necessary for the sake of the description, and do not necessarily indicate all the control lines and information lines required for implementation. In practice, almost all the configurations may be considered to be interconnected.

### REFERENCE SIGNS LIST

1, 3 development environment
2, 4 execution environment
5, 6 electronic control device
7 network
11 source code
12 common IF unit library
13 compiler
14, 23, 51, 61, 52 execution binary
21, 41 initialization unit
22 execution binary storage unit
24 IF conversion unit
25, 32, 45 emulation unit
26 host OS library
27 log unit
31 emulation library
33, 43 reference function information
42 provided function information
44 binary addition unit
53 additional function
54, 62 communication library
141, 231 command code
142, 232 common IF unit
242 common IF unit

1. An electronic control device, comprising a processor that executes a program operating on an operating system, and a storage device that stores the program,
wherein the storage device stores the operating system, the program, and an intermediate layer library operating on the operating system, which are individually configured,
the operating system includes a host OS library in which a function to be called is recorded during execution of the program,
the program includes executable command code and a common IF unit in which a jump destination of a function called by the program is recorded,
the intermediate layer library includes an emulation unit including a function emulator that implements another function by combining functions stored in the host OS library, and an IF conversion unit that converts an address for the common IF unit to call the emulation unit and the host OS library, and
the operating system, the intermediate layer library, and the program are introduced to the electronic control device separately.

2. The electronic control device according to claim 1,
wherein the program includes reference function information in which functions used by the emulation unit and functions referenced by the command code are stored,
the electronic control device further comprising a binary addition unit that, among the functions referenced by the command code, stores a function not prepared by the emulation unit.

3. The electronic control device according to claim 1, comprising a log unit for storing error information determined by the IF conversion unit,
wherein the emulation unit uses the information stored in the log unit to update functions so as to leave functions having a high usage frequency and delete functions having a low usage frequency.

4. The electronic control device according to claim 2, wherein, in a case where the program is migrated from another electronic control device, a function not prepared by the emulation unit, among the functions referenced by the migrated program, is stored in the binary addition unit.
